(19) United States
(12) Patent Application Publication
(10) Pub. No.: US 2021/0383774 A1
(43) Pub. Date: Dec. 9, 2021

(54) INFORMATION PROCESSING APPARATUS AND NON-TRANSITORY COMPUTER READABLE MEDIUM

(71) Applicant: FUJIFILM BUSINESS INNOVATION CORP., Tokyo (JP)

(72) Inventor: Kengo TOKUCHI, Kanagawa (JP)

(73) Assignee: FUJIFILM BUSINESS INNOVATION CORP., Tokyo (JP)

(21) Appl. No.: 17/112,040

(22) Filed: Dec. 4, 2020

(30) Foreign Application Priority Data
Jun. 4, 2020 (JP) 2020-097946

(51) Int. Cl. G09G 5/37; G09G 3/00; G06F 3/01; G06T 13/40; G06T 13/80

(52) U.S. Cl. CPC G09G 5/37; G09G 3/035; G06F 3/016; G06F 3/044; G06T 13/80; G09G 2354/00; G09G 2380/02; G06T 13/40

(57) ABSTRACT

An information processing apparatus includes a processor configured to change a representation of an image of an object displayed on a deformable display in accordance with a change in tilt of a partial display area occurring due to a shape change of the deformable display.

### CROSS-REFERENCE TO RELATED APPLICATIONS

This application is based on and claims priority under 35 USC 119 from Japanese Patent Application No. 2020-097946 filed Jun. 4, 2020.

### BACKGROUND

### Technical Field

The present disclosure relates to an information processing apparatus and a non-transitory computer readable medium.

### Related Art

Display devices capable of deforming their display surface have been currently put to practical use. Deformation of the display surface is not limited to the case where the display device itself is deformed, and includes the case where the mounting angle at which multiple members are connected by a hinge or the like changes. In the latter case, the entire display surface constituted of multiple display devices that are adjacent to each other across the hinge deforms. Such an exemplary technique of the related art is disclosed in Japanese Unexamined Patent Application Publication No. 2017-187669.

In the case of the display surface in a flat state, a tilt angle observed from the outside remains the same at any position on the display surface. However, if the display surface is deformed, multiple tilt angles appear on the display surface. The display method after the deformation includes the case of displaying independent images in plural areas separated across an area where the tilt angle changes and the case of displaying one image across an area where the tilt angle changes. In either case, even if an object moves from one area to another area having different tilt angles, how the object is displayed is not affected by the tilt angle of the display device.

### SUMMARY

Aspects of non-limiting embodiments of the present disclosure relate to enabling various representations reflecting the physical deformation of a display device as compared to the case where, when the tilt angle of an area changes as the shape of a display surface changes, even if an image of a specific object moves to another area having a different tilt angle, the representation of the image is not affected by the tilt angle.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to change a representation of an image of an object displayed on a deformable display in accordance with a change in tilt of a partial display area occurring due to a shape change of the deformable display.

### BRIEF DESCRIPTION OF THE DRAWINGS

Exemplary embodiments of the present disclosure will be described in detail based on the following figures, wherein:

FIGS. 1A and 1B are diagrams illustrating an example of the appearance configuration of an information terminal used in a first exemplary embodiment, that is, FIG. 1A is a front view of the information terminal, and FIG. 1B is a side view of the information terminal;

FIG. 2 is a diagram illustrating two display areas formed by folding and deforming a touchscreen;

FIGS. 3A to 3C are diagrams illustrating exemplary changes in shape of the information terminal in the first exemplary embodiment, that is, FIG. 3A illustrates the information terminal used in a flat state, FIG. 3B illustrates the information terminal deformed as a result of a mountain fold, and FIG. 3C illustrates the information terminal deformed as a result of a valley fold;

FIG. 4 is a diagram illustrating an example of the hardware configuration of the information terminal used in the first exemplary embodiment;

FIG. 5 is a diagram illustrating an example of a scene where an image of an object, which is an example of an object, moves across a boundary from a lower display area to an upper display area;

FIG. 6 is a flowchart illustrating an example of a process operation executed by the information terminal used in the first exemplary embodiment;

FIGS. 7A and 7B are diagrams illustrating an example of the information terminal deformed as a result of a valley fold, that is, FIG. 7A illustrates how the object image displayed in one display area moves at a velocity in a direction toward another display area, and FIG. 7B is a side view of the information terminal deformed as a result of a valley fold;

FIGS. 8A and 8B are diagrams illustrating an example of a change in movement velocity in the case where the information terminal is deformed as a result of a valley fold, that is, FIG. 8A indicates the position at each time of the object image displayed on the information terminal, and FIG. 8B indicates the velocity at each time used to move the object image;

FIGS. 9A and 9B are diagrams illustrating another example of a change in movement velocity in the case where the information terminal is deformed as a result of a valley fold, that is, FIG. 9A indicates the position at each time of the object image displayed on the information terminal, and FIG. 9B indicates the velocity at each time used to move the object image;

FIGS. 10A and 10B are diagrams illustrating another example of a change in movement velocity in the case where the information terminal is deformed as a result of a valley fold, that is, FIG. 10A indicates the position at each time of the object image displayed on the information terminal, and FIG. 10B indicates the velocity at each time used to move the object image;

FIGS. 11A and 11B are diagrams illustrating an example of the information terminal deformed as a result of a mountain fold, that is, FIG. 11A illustrates how the object image displayed in one display area moves at a velocity in a direction toward another display area, and FIG. 11B is a side view of the information terminal deformed as a result of a mountain fold;

FIGS. 12A and 12B are diagrams illustrating an example of a change in movement velocity in the case where the information terminal is deformed as a result of a mountain fold, that is, FIG. 12A indicates the position at each time of the object image displayed on the information terminal, and FIG. 12B indicates the velocity at each time used to move the object image;

FIGS. 13A and 13B are diagrams illustrating another example of a change in movement velocity in the case where the information terminal is deformed as a result of a mountain fold, that is, FIG. 13A indicates the position at each time of the object image displayed on the information terminal, and FIG. 13B indicates the velocity at each time used to move the object image;

FIG. 14 is a flowchart illustrating an example of a process operation executed by the information terminal used in a second exemplary embodiment;

FIG. 15 is a diagram illustrating changes in representation in the case of deformation as a result of a valley fold;

FIG. 16 is a diagram illustrating changes in representation in the case of deformation as a result of a mountain fold;

FIG. 17 is a diagram illustrating an example of the hardware configuration of an information terminal used in a third exemplary embodiment;

FIG. 18 is a diagram illustrating a change in frictional force applied to a fingertip in the case where the object image is moved across two display areas formed by deformation as a result of a valley fold;

FIG. 19 is a diagram illustrating a change in frictional force applied to a fingertip in the case where the object image is moved across two display areas formed by deformation as a result of a mountain fold;

FIGS. 20A and 20B are diagrams illustrating an example of installing strain gauges in an information terminal used in a fourth exemplary embodiment, that is, FIG. 20A is a front view of the information terminal, and FIG. 20B is a side view of the information terminal;

FIG. 21 is a diagram illustrating an example of the hardware configuration of the information terminal used in the fourth exemplary embodiment;

FIGS. 22A and 22B are diagrams illustrating the case where a display area corresponding to the movement destination for the object image is flat, that is, FIG. 22A indicates the relationship between a display area at the movement source and a display area at the movement destination in the case of deformation as a result of a mountain fold, and FIG. 22B indicates the relationship between a display area at the movement source and a display area at the movement destination in the case of deformation as a result of a valley fold;

FIG. 23 is a diagram illustrating an example of the appearance configuration of another information terminal;

FIGS. 24A to 24C are diagrams illustrating an example of the appearance configuration of another information terminal, that is, FIG. 24A is a front view of the information terminal, FIG. 24B is a side view of the information terminal, and FIG. 24C illustrates an example of the shape of the information terminal after being deformed; and

FIGS. 25A and 25B are diagrams illustrating an example of the appearance configuration of another information terminal, that is, FIG. 25A is a front view of the information terminal, and FIG. 25B is a side view of the information terminal.

### DETAILED DESCRIPTION

Hereinafter, exemplary embodiments of the present disclosure will be described with reference to the drawings.

### First Exemplary Embodiment

### Configuration of Apparatus

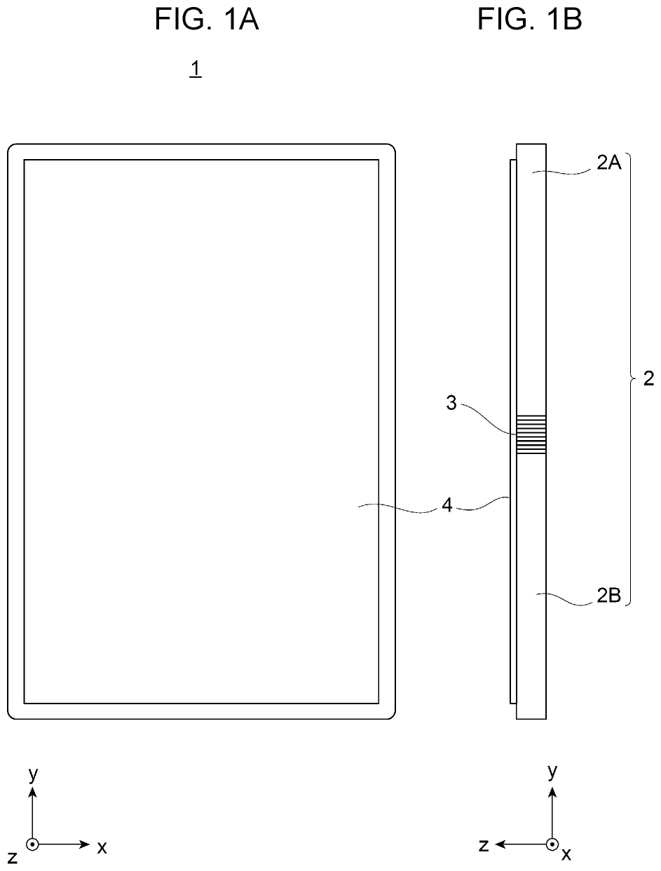

FIGS. 1A and 1B are diagrams illustrating an example of the appearance configuration of an information terminal 1 used in a first exemplary embodiment. FIG. 1A is a front view of the information terminal 1, and FIG. 1B is a side view of the information terminal 1. The information terminal 1 is an example of an information processing apparatus.

The information terminal 1 illustrated in FIGS. 1A and 1B assumes, for example, a tablet computer or a smartphone. Needless to say, the information terminal 1 may be a game machine or a wearable terminal.

A main body 2 of the information terminal 1 in the present exemplary embodiment includes two main body panels 2A and 2B.

Inside the main body panels 2A and 2B, built-in parts (not illustrated) that enable operation as a computer are provided. The two main body panels 2A and 2B are connected to each other via a hinge part 3. The hinge part 3 used in the present exemplary embodiment is located at a position that divides a touchscreen 4 in the long side direction into two. In the case of FIGS. 1A and 1B, the long side direction of the touchscreen 4 is the y-axis direction, and the short side direction is the x-axis direction.

The hinge part 3 in the present exemplary embodiment is deformable both in a mountain fold direction and a valley fold direction. Needless to say, the information terminal 1 may be deformable only in a mountain fold direction or deformable only in a valley fold direction. Hereinafter, deformation in a mountain fold direction and deformation in a valley fold direction may also be phrased as folding and deformation, without making a distinction between the two.

In the case of the present exemplary embodiment, one foldable and deformable touchscreen 4 is used.

The touchscreen 4 includes an organic electroluminescent (EL) display where light-emitting elements are arranged on a film-shaped plastic substrate, and an electrostatic-capacitance film sensor (hereinafter referred to as a “film sensor”) located on the surface of the organic EL display.

The film sensor has characteristics that do not hinder the observation of an image displayed on the organic EL display and is used to detect a position operated by a user.

The organic EL display in the present exemplary embodiment is an example of a deformable and continuous display surface. In other words, the organic EL display has a display surface formed on the plastic substrate.

In the present exemplary embodiment, deformation giving rise to a ridge line on the touchscreen 4 is referred to as “deformation as a result of a mountain fold”, and deformation giving rise to a valley line on the touchscreen 4 is referred to as “deformation as a result of a valley fold”.

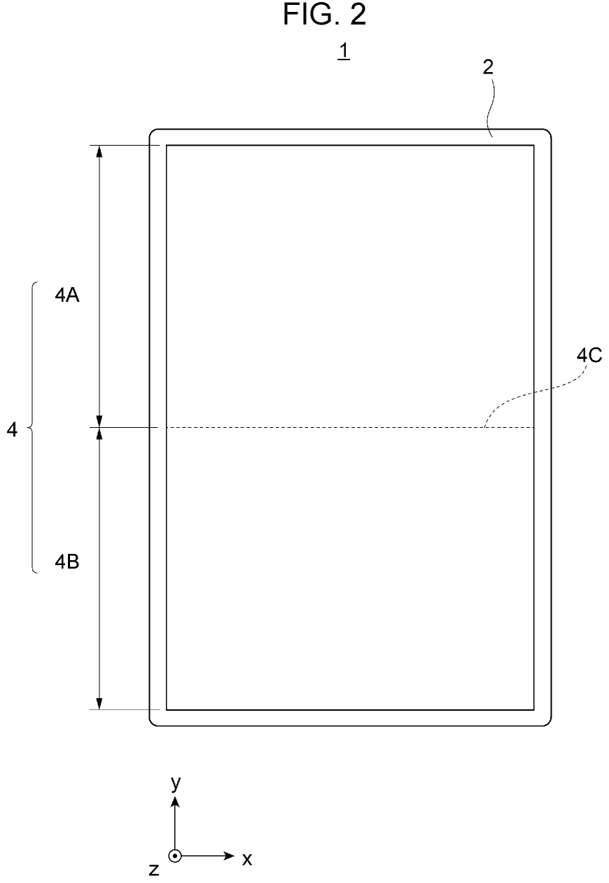

FIG. 2 is a diagram illustrating two display areas 4A and 4B formed by folding and deforming the touchscreen 4.

The touchscreen 4 that is neither folded nor deformed is managed as one display area, as illustrated in FIG. 1A. However, the touchscreen 4 that is folded and deformed is managed separately as the two display areas 4A and 4B. The two display areas A4 and 4B in the present exemplary embodiment have the same shape.

In FIG. 2, the boundary between the two display areas 4A and 4B is indicated as a boundary 4C.

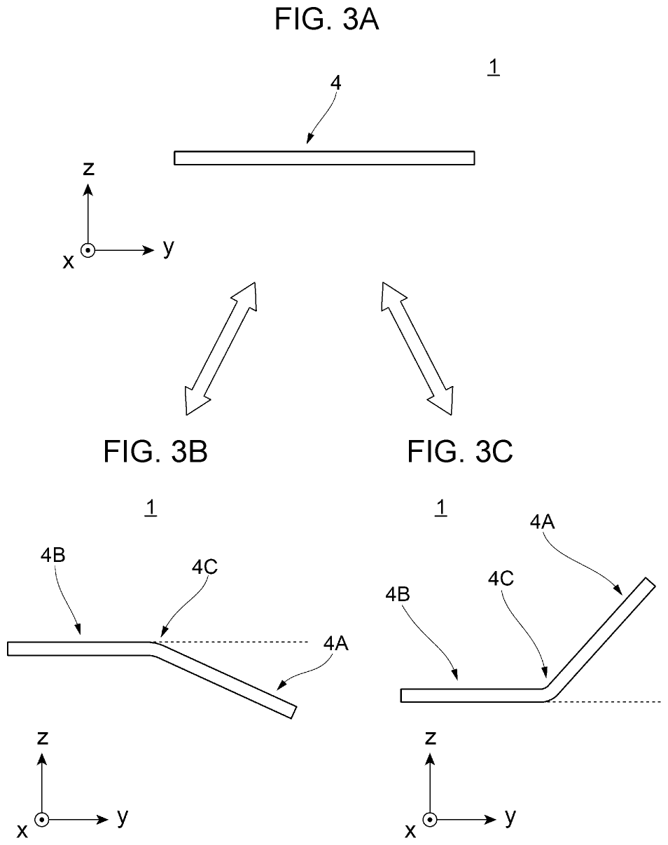

FIGS. 3A to 3C are diagrams illustrating an example of a change in shape of the information terminal 1 in the first exemplary embodiment, that is, FIG. 3A illustrates the information terminal 1 used in a flat state, FIG. 3B illustrates the information terminal 1 deformed as a result of a mountain fold, and FIG. 3C illustrates the information terminal deformed as a result of a valley fold. In FIGS. 3A to 3C, portions corresponding to those in FIG. 2 are given the corresponding reference numerals. The shape illustrated in FIG. 3B is a deformed shape in which the information terminal 1, which is used in a flat state, is pushed downward on the right side. The shape illustrated in FIG. 3C is a deformed shape in which the information terminal 1, which is used in a flat state, is pushed upward on the right side.

### Hardware Configuration

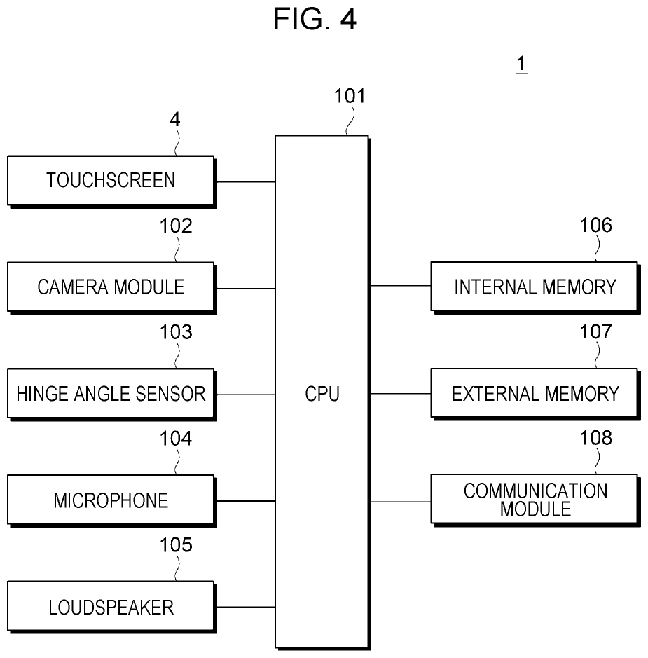

FIG. 4 is a diagram illustrating an example of the hardware configuration of the information terminal 1 used in the first exemplary embodiment.

The information terminal 1 used in the present exemplary embodiment includes the following: a central processing unit (CPU) 101, which controls each unit through execution of a program; the touchscreen 4, which is used to input/output information; a camera module 102, which captures an image of a person or a landscape; a hinge angle sensor 103, which detects the opening angle of the hinge part 3 (see FIG. 1B); a microphone 104, which is used for conversations or recordings; a loudspeaker 105, which is used for playing sound; internal memory 106, which stores system data and internal data; detachable external memory 107; and a communication module 108, which is used for communication with an external apparatus. In the case of the present exemplary embodiment, semiconductor memory is used for the internal memory 106 and the external memory 107.

The CPU 101 in the present exemplary embodiment realizes various functions through execution of programs (hereinafter may also be referred to as “apps”) stored in the internal memory 106. The internal memory 106 includes, for example, random-access memory (RAM) and flash memory. The CPU 101 and the internal memory 106 constitute a computer.

For example, a complementary metal oxide semiconductor (CMOS) sensor is used in the camera module 102. In the case of the present exemplary embodiment, the camera module 102 is provided on both of a face on which the touchscreen 4 is provided and a face opposite to the touchscreen 4. Note that the number of camera modules 102 provided on the main body 2 may be three or more.

The hinge angle sensor 103 outputs information regarding an angle formed by the main body panel 2A and the main body panel 2B in the case where the main body 2 is deformed around the hinge part 3. In other words, the hinge angle sensor 103 outputs the angle of a fold. Note that the angle of rotation of gears constituting the hinge part 3 may be output as information representing the angle of a fold.

The microphone 104 is a device that converts the user's voice or ambient sound to an electrical signal.

The loudspeaker 105 is a device that converts an electrical signal to sound and outputs the sound.

For example, a Bluetooth (registered trademark) module or a wireless local area network (LAN) module is used for the communication module 108.

### Process Operation

Hereinafter, a process operation executed in the case where the information terminal 1 (see FIGS. 1A and 1B) used in the present exemplary embodiment displays an image on the touchscreen 4 (see FIGS. 1A and 1B) will be described.

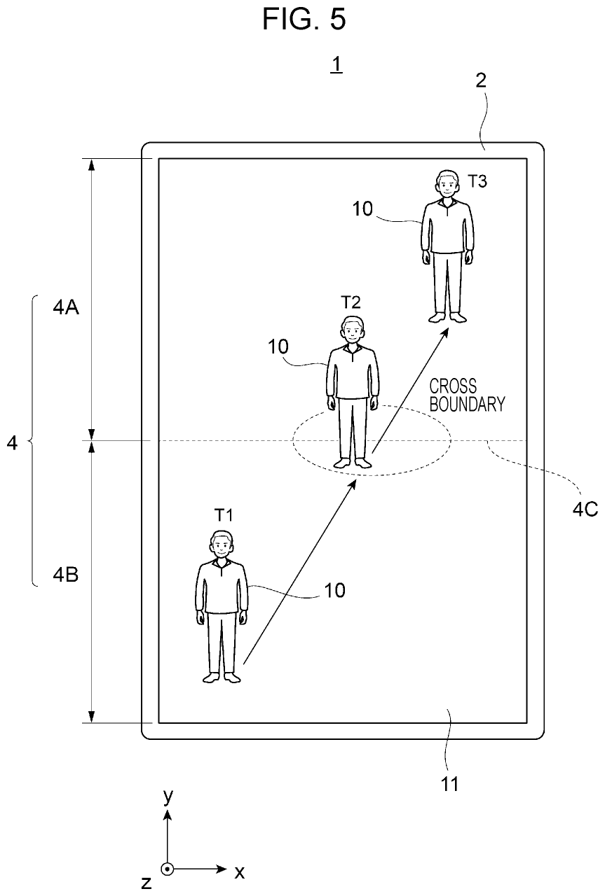

At first, using FIG. 5, a scene that serves as a premise for the process operation described below will be described.

FIG. 5 is a diagram illustrating an example of a scene where an image 10 of an object (hereinafter referred to as an “object image 10”), which is an example of an object, moves across the boundary 4C from the lower display area 4B to the upper display area 4A.

The term “object” in the present exemplary embodiment is used in the sense of a unit of rendering. Therefore, even when multiple animals or living things are displayed on the screen, if they are treated as one image, they are one object.

In the case of the present exemplary embodiment, an image displayed on the touchscreen 4 is designed as a virtual world, like a world in a game machine. That is, the present exemplary embodiment assumes the case of displaying an image of a virtual reality on the touchscreen 4.

In the present exemplary embodiment, objects displayed on the touchscreen 4 are distinguished into the object image 10 and a background image 11.

The background image 11 is basically located behind the object image 10 and defines a space where the object image 10 exists. The background image 11 is not limited to the case where the background image 11 includes one object, and the background image 11 may be configured as a set of multiple objects. In addition, in the case where the front-back relationship based on a virtual viewpoint is defined for each object, the object image 10 may sometimes be hidden behind an object included in the background image 11.

The object image 10 in the present exemplary embodiment is located in front of the background image 11. The movement and changes in display form of the object image 10 are controlled independently of the background image 11.

In the case of FIG. 5, the object image 10 is rendered as a humanoid character. Needless to say, the object image 10 may be a character that resembles an animal or a living thing. A character is an object given anthropomorphic characteristics. A character may be an avatar which is another representation of the user.

In addition, the object image 10 may be an object that resembles a coin, a stone, a jewel, or the like, or an object that resembles a vehicle such as an automobile, a bicycle, an airplane, or a ship. In the present exemplary embodiment, among clothes and hats worn by the object image 10 and belongings of the object image 10, objects displayed independently of the object image 10 are referred to as objects that decorate the object image 10, and are distinguished from the object image 10. In addition, sweat, tears, and steam rising from the body are included in objects that decorate the object image 10.

Although there is one object image 10 in the case of FIG. 5, there may be multiple object images 10. There is one object image 10 in the case of FIG. 5 in order to simplify the process operation regarding display which is executed by the information terminal 1.

Although the object image 10 is positioned in the display area 4B at time T1 in the case of FIG. 5, the object image 10 moves to the position of the boundary 4C at time T2, and is positioned in the display area 4A at time T3.

In the present exemplary embodiment, the movement of the object image 10 from the display area 4B to another display area 4A or the movement of the object image 10 from the display area 4A to another display area 4B is referred to as the movement of the object image 10 across the boundary 4C. In other words, this movement may alternatively be referred to as “crossing the boundary”.

Note that the object image 10 and the background image 11 may be two-dimensional objects or three-dimensional objects.

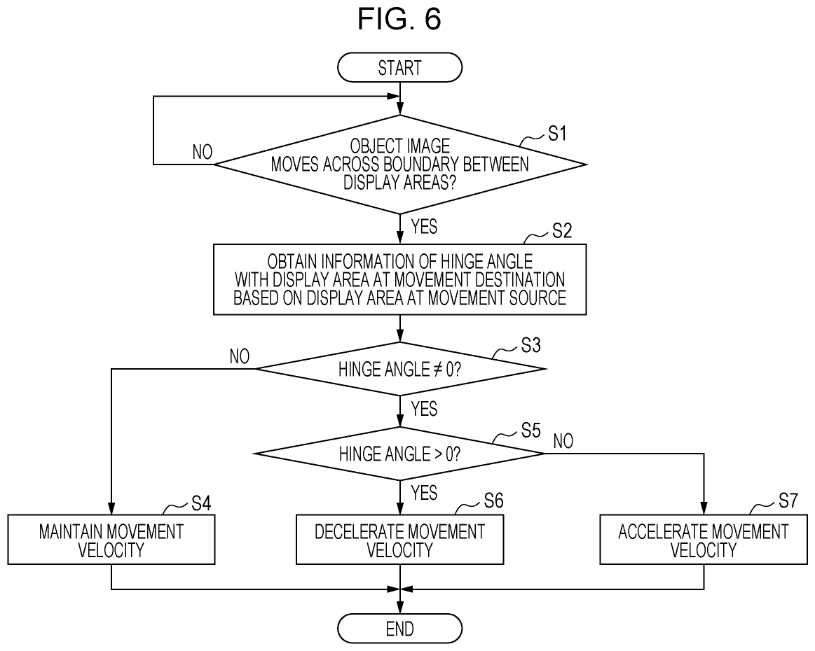

FIG. 6 is a flowchart illustrating an example of a process operation executed by the information terminal 1 used in the first exemplary embodiment. The symbol S in the flowchart denotes a step.

The process operation described using FIG. 6 assumes the case in which the object image 10 (see FIG. 5) displayed on the touchscreen 4 (see FIGS. 1A and 1B) moves across the boundary 4C (see FIG. 2), which is the folding position.

The CPU 101 (see FIG. 4) determines whether the object image 10 (see FIG. 5) has moved across the boundary 4C (see FIG. 5) between the display areas 4A and 4B (see FIG. 5) (step S1). The movement here may be started by a user operation or under control of an app.

A user operation used for designating the movement of the object image 10 includes, for example, an operation in which the user swipes the surface of the touchscreen 4 with a fingertip, and an operation in which the user slides on the touchscreen 4 in the direction opposite to where the user wants to move the object image 10 to and then releasing the user's hand. An operation in which the user pulls a fingertip in the direction opposite to where the user wants to move the object image 10 to corresponds to an operation of holding a bullet in a rubber string attached to a Y-shaped frame, pulling the rubber string, and then releasing the hand, or an operation of pulling a string attached to both ends of a bow with an arrow and then releasing the hand.

In the case of a swipe operation in the direction in which the user wants to move the object image 10, the velocity at which the object image 10 moves is determined according to the speed of the swipe operation. In contrast, in the case of a slide operation in the direction opposite to the direction in which the user wants to move the object image 10, the velocity at which the object image 10 moves is determined according to the distance the user slides.

While the condition in step S1 is not satisfied, the CPU 101 obtains a negative result in step S1 and repeats the determination in step S1. At the determination time, in the case where the object image 10 is present in the same display area as that at the previous determination time, the CPU 101 obtains a negative result in step S1.

In contrast, in response to detection of movement across the boundary 4C, the CPU 101 obtains an affirmative result in step S1. Movement across the boundary 4C may be movement from the display area 4A to the display area 4B or movement from the display area 4B to the display area 4A.

Having obtained an affirmative result in step S1, the CPU 101 obtains information of the hinge angle with the display area at the movement destination based on the display area at the movement source (step S2). Information of the hinge angle is given in terms of, for example, degrees. Needless to say, in the case where the hinge part 3 (see FIG. 1B) includes gears, the number of rotated teeth may be given as information of the hinge angle, or the number of rotations of a specific gear may be given as information of the hinge angle.

In the case of the present exemplary embodiment, the hinge angle in a flat state, that is, in a state where there is no deformation, is 0 degrees. Note that, in the case of crossing the boundary 4C when folding and deformation is a valley fold, the hinge angle takes a positive value. In contrast, in the case of crossing the boundary 4C when folding and deformation is a mountain fold, the hinge angle takes a negative value. That is, the hinge angle being positive or negative represents the direction of tilt of the display area at the movement destination with respect to the display area at the movement source.

Note that the measure of the hinge angle represents the magnitude of a change in the tilt angle between the display area 4A and the display area 4B.

Next, the CPU 101 determines whether the hinge angle is other than 0 degrees (step S3). In the case where the hinge angle is 0 degrees, the CPU 101 obtains a negative result in step S3. This case indicates that the touchscreen 4 is in a flat state, that is, a state where the touchscreen 4 is neither folded nor deformed. At this time, the CPU 101 maintains the movement velocity of the object image 10 after the object image 10 crosses the boundary 4C (step S4).

In contrast, in the case where an affirmative result is obtained in step S3, the CPU 101 determines whether the hinge angle is positive (step S5).

In the case where the hinge angle is positive, that is, in the case where the touchscreen 4 is deformed as a result of a valley fold, the CPU 101 obtains an affirmative result in step S5. In this case, the CPU 101 decelerates the movement velocity of the object image 10 after the object image 10 crosses the boundary 4C (step S6).

In contrast, in the case where the hinge angle is negative, that is, in the case where the touchscreen 4 is deformed as a result of a mountain fold, the CPU 101 obtains a negative result in step S5. In this case, the CPU 101 accelerates the movement velocity of the object image 10 after the object image 10 crosses the boundary 4C (step S7).

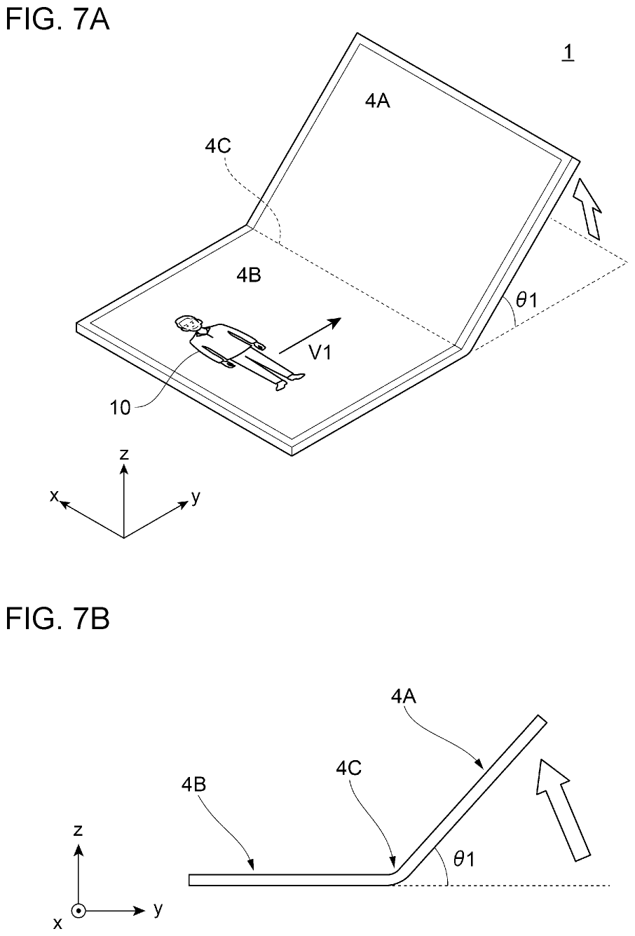

Hereinafter, changes that occur on the displayed screen in the present exemplary embodiment will be described using FIGS. 7A to 13B.

FIGS. 7A and 7B are diagrams illustrating an example of the information terminal 1 deformed as a result of a valley fold. FIG. 7A illustrates how the object image 10 displayed in the display area 4B moves at a velocity V1 in a direction toward the display area 4A, and FIG. 7B is a side view of the information terminal 1 deformed as a result of a valley fold. In the case of FIGS. 7A and 7B, the magnitude of a change in the tilt angle generated across the boundary 4C is represented by θ1.

In the case of the present exemplary embodiment, it is assumed that θ1 is greater than or equal to 0 degrees and less than or equal to 90 degrees. If θ1 is greater than 90 degrees, which is possible, it is difficult to observe both the display area 4A and the display area 4B at once. Accordingly, the upper limit of θ1 is 90 degrees in the present exemplary embodiment.

In the case of the present exemplary embodiment, it is assumed that the display area 4B where the object image 10 before the movement is positioned is parallel to a horizontal plane. Therefore, the display area 4A which is at the destination after crossing the boundary 4C is uphill with respect to the display area 4B.

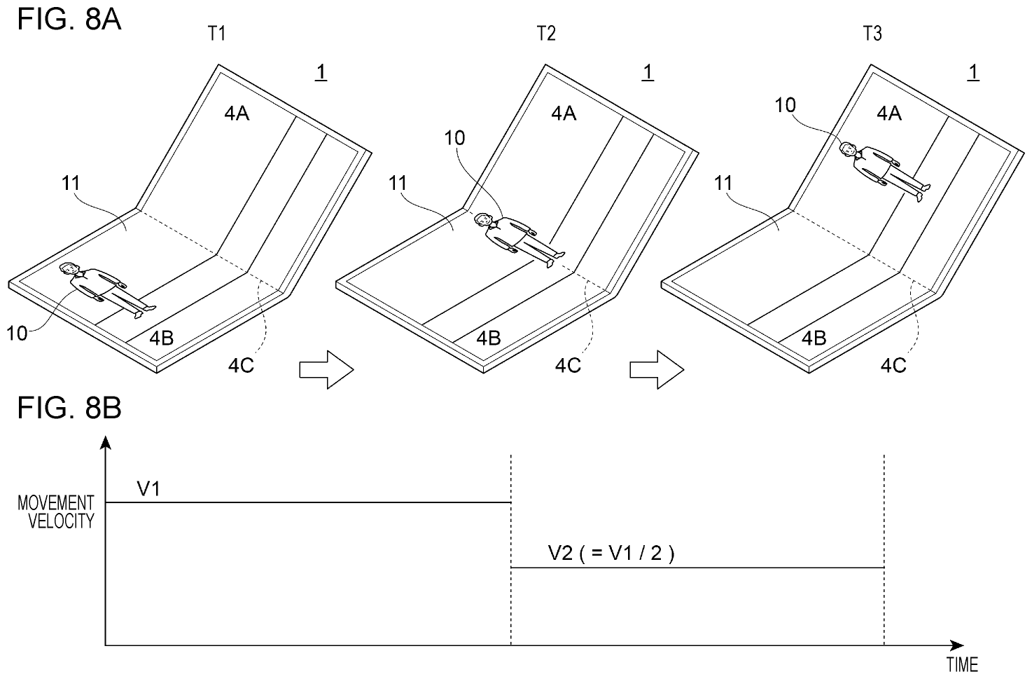

FIGS. 8A and 8B are diagrams illustrating an example of a change in movement velocity in the case where the information terminal 1 is deformed as a result of a valley fold. FIG. 8A indicates the position at each time of the object image 10 displayed on the information terminal 1, and FIG. 8B indicates the velocity at each time used to move the object image 10.

In the case of FIGS. 8A and 8B, one road is drawn on the background image 11, and the object image 10 moves along the road on the background image 11. In the case of FIGS. 8A and 8B, the velocity at which the object image 10 moves in the display area 4B is V1. In the case of FIGS. 8A and 8B, when the object image 10 crosses the boundary 4C and moves to the display area 4A, the movement velocity of the object image 10 from that time point is decelerated to V2. In the case of FIGS. 8A and 8B, the velocity V2 is half the velocity V1.

In the case of FIGS. 8A and 8B, a change in the tilt angle from the display area 4B to the display area 4A is a change from a flat road to an uphill road.

In the case of the present exemplary embodiment, the movement velocity is decelerated to half, regardless of the magnitude of a change in the tilt angle. Therefore, the movement velocity of the object image 10 becomes slower immediately after the object image 10 crosses the boundary 4C. In the case of FIGS. 8A and 8B, the time required for movement in the display area 4A is twice the time required for moving the same distance in the display area 4B.

Note that the fact that the velocity V2 is half the velocity V1 is only one example, and the velocity V2 only needs to be decelerated relatively. As above, in the case of the present exemplary embodiment, a change in the tilt angle between two display areas may be reflected in a change in the movement velocity of the object image 10 being displayed. This movement velocity may be realized by intentional folding and deformation of the information terminal 1 by the user.

In addition, the velocity V2 may take multiple values. For example, the velocity V2 may be discontinuously decelerated over time. For example, the velocity V2 may be decelerated to half the velocity V1 at first, and then reduced to one-third of the velocity V1.

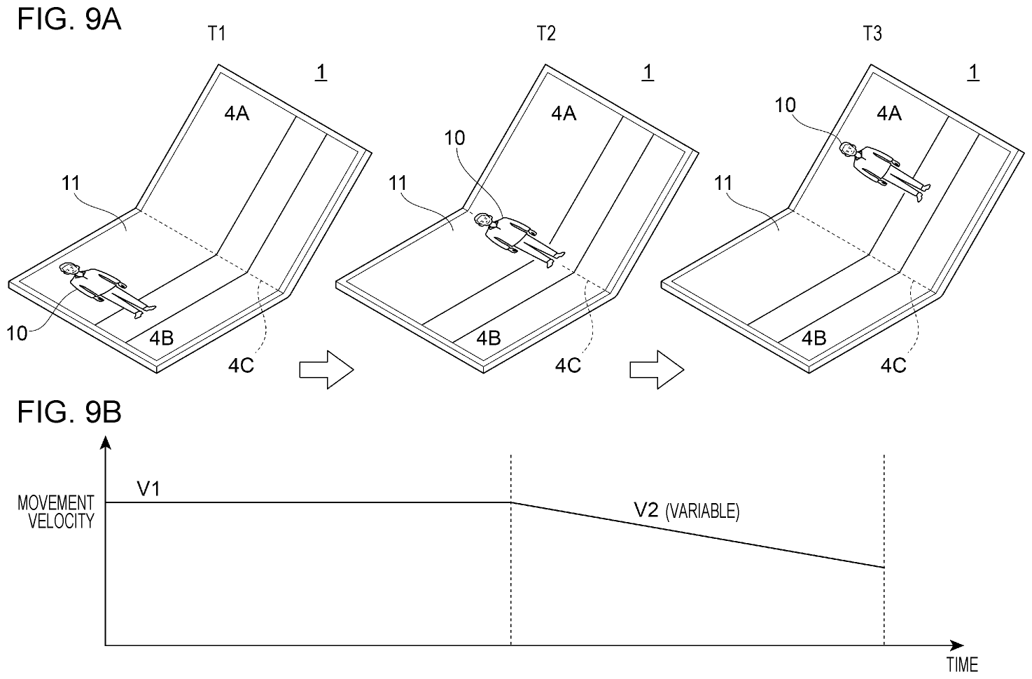

FIGS. 9A and 9B are diagrams illustrating another example of a change in movement velocity in the case where the information terminal 1 is deformed as a result of a valley fold. FIG. 9A indicates the position at each time of the object image 10 displayed on the information terminal 1, and FIG. 9B indicates the velocity at each time used to move the object image 10. In FIGS. 9A and 9B, portions corresponding to those in FIGS. 8A and 8B are given the corresponding reference numerals.

In the case of FIGS. 9A and 9B, the movement velocity of the object image 10 in the display area 4A is different from that in FIGS. 8A and 8B in the point that the movement velocity is gradually reduced over time.

The initial value of the velocity V2 in the display area 4A is the same as the movement velocity V1 in the display area 4B. Unlike the case of FIGS. 8A and 8B, the movement velocity in the case of FIGS. 9A and 9B does not change discontinuously, resulting in a less uncomfortable feeling inspired by a change in velocity.

Note that the deceleration of the object image 10 may be stopped at a specific velocity. For example, when the movement velocity becomes one-third of the velocity V1, that movement velocity may be maintained.

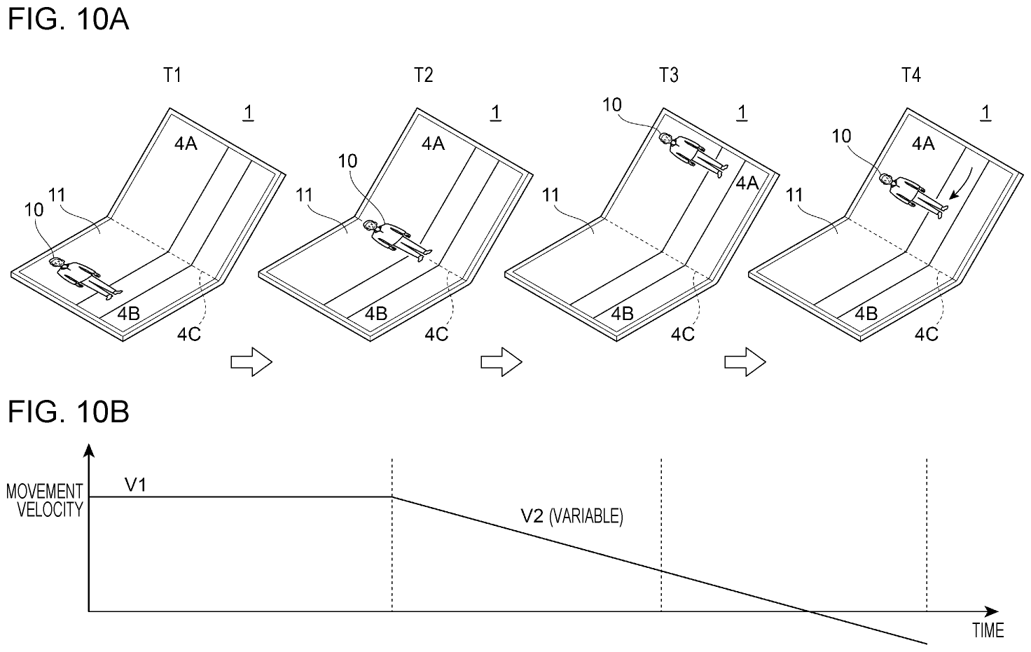

FIGS. 10A and 10B are diagrams illustrating another example of a change in movement velocity in the case where the information terminal 1 is deformed as a result of a valley fold. FIG. 10A indicates the position at each time of the object image 10 displayed on the information terminal 1, and FIG. 10B indicates the velocity at each time used to move the object image 10. In FIGS. 10A and 10B, portions corresponding to those in FIGS. 9A and 9B are given the corresponding reference numerals.

The example illustrated in FIGS. 10A and 10B indicates the case where the velocity of the object image 10, which is moving in the display area 4A, becomes zero, and eventually the movement velocity takes a negative value. A velocity having a negative value means movement in the opposite direction. That is, the object image 10, which continues to decelerate in the display area 4A, stops after the continuous deceleration, and then starts moving in a direction opposite to the immediately preceding direction. Therefore, the object image 10, which has moved close to an end portion in the display area 4A, returns to the vicinity of the middle portion of the display area 4A at time T4.

Note that, in the examples illustrated in FIGS. 8A to 10B, the movement velocity of the object image 10 in the display area 4A is constant regardless of the magnitude of a change in the tilt angle with respect to the display area 4B. However, the magnitude of an effect of deceleration on the object image 10 in the display area 4A may be adjusted according to the magnitude of a change in the tilt angle. For example, the effect of deceleration may be greater as the change in the tilt angle becomes greater. For example, the effect of deceleration may be greater in the case where the change in tilt angle is 45 degrees than in the case where the change in tilt angle is 30 degrees, and the effect of deceleration may be greater in the case where the change in tilt angle is 60 degrees than in the case where the change in tilt angle is 45 degrees.

In addition, although the examples illustrated in FIGS. 8A to 10B indicate the case where the movement velocity of the object image 10 in the display area 4B is constant, the movement velocity of the object image 10 in the display area 4B may be variable. For example, the object image 10 in the display area 4B may be accelerated or decelerated.

In addition, the change in movement velocity in the display areas 4A and 4B is not limited to be linear, but may be non-linear. For example, the movement velocity may change along a quadratic function or an exponential function. In addition, the movement velocity may be increased or decreased over time. The velocity is not limited to be increased or decreased once, but may be increased or decreased multiple times.

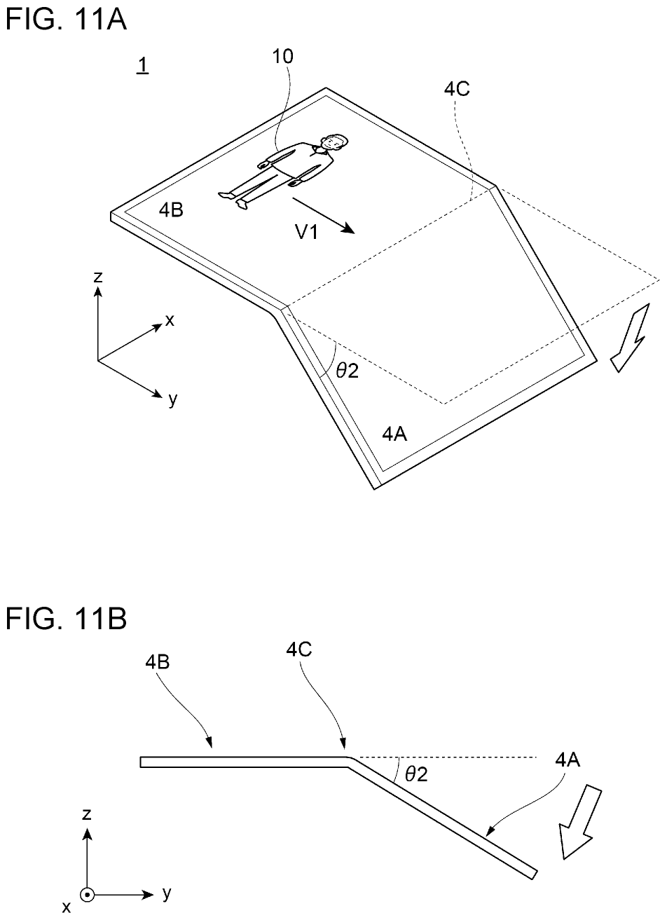

FIGS. 11A and 11B are diagrams illustrating an example of the information terminal 1 deformed as a result of a mountain fold. FIG. 11A illustrates how the object image 10 displayed in the display area 4B moves at the velocity V1 in a direction toward the display area 4A, and FIG. 11B is a side view of the information terminal 1 deformed as a result of a mountain fold. In the case of FIGS. 11A and 11B, the magnitude of a change in the tilt angle generated across the boundary 4C is represented by θ2.

In the case of the present exemplary embodiment, it is assumed that θ2 is greater than or equal to 0 degrees and less than or equal to 90 degrees. If θ2 is greater than 90 degrees, which is possible, it is difficult to observe both the display area 4A and the display area 4B at once. Accordingly, the upper limit of θ2 is 90 degrees in the present exemplary embodiment.

In the case of the present exemplary embodiment, it is assumed that the display area 4B where the object image 10 before the movement is positioned is parallel to a horizontal plane. Therefore, the display area 4A which is at the destination after crossing the boundary 4C is downhill with respect to the display area 4B.

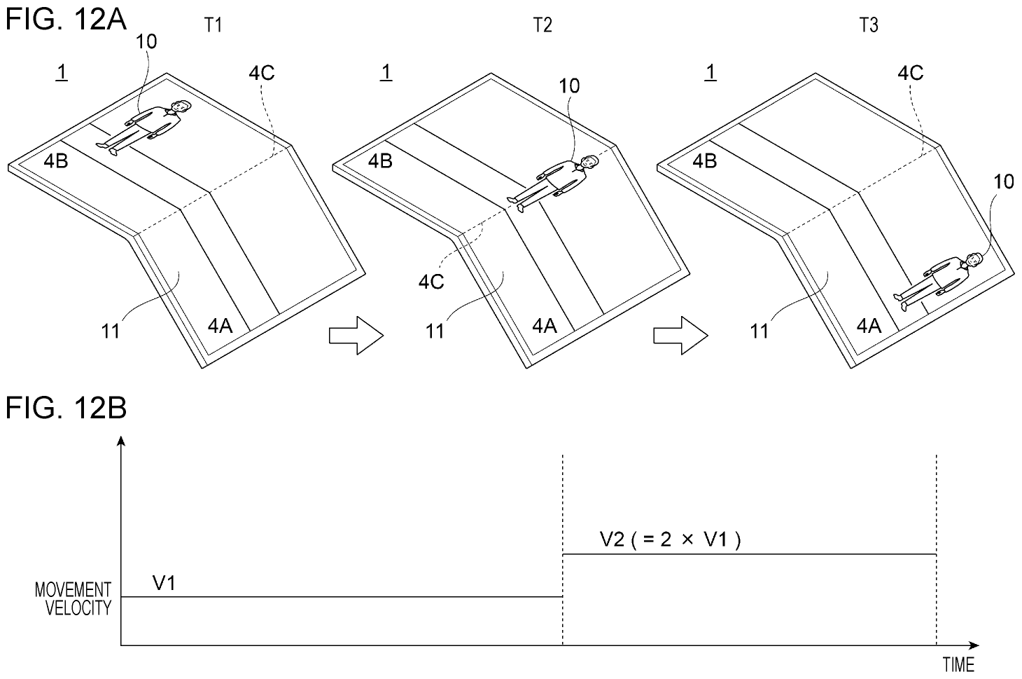

FIGS. 12A and 12B are diagrams illustrating an example of a change in movement velocity in the case where the information terminal 1 is deformed as a result of a mountain fold. FIG. 12A indicates the position at each time of the object image 10 displayed on the information terminal 1, and FIG. 12B indicates the velocity at each time used to move the object image 10.

Also, in the case of FIGS. 12A and 12B, one road is drawn on the background image 11, and the object image 10 moves along the road on the background image 11. In the case of FIGS. 12A and 12B, the velocity at which the object image 10 moves in the display area 4B is V1. In the case of FIGS. 12A and 12B, when the object image 10 crosses the boundary 4C and moves to the display area 4A, the movement velocity of the object image 10 from that time point is accelerated to V2. In the case of FIGS. 12A and 12B, the velocity V2 is twice the velocity V1.

In the case of FIGS. 12A and 12B, a change in the tilt angle from the display area 4B to the display area 4A is a change from a flat road to a downhill road.

In the case of the present exemplary embodiment, the movement velocity is accelerated to double, regardless of the magnitude of a change in the tilt angle. Therefore, the movement velocity of the object image 10 becomes faster immediately after the object image 10 crosses the boundary 4C. In the case of FIGS. 12A and 12B, the time required for movement in the display area 4A is half the time required for moving the same distance in the display area 4B.

Note that the fact that the velocity V2 is twice the velocity V1 is only one example, and the velocity V2 only needs to be accelerated relatively. As above, in the case of the present exemplary embodiment, a change in the tilt angle between two display areas may be reflected in a change in the movement velocity of the object image 10 being displayed. This movement velocity may be realized by intentional folding and deformation of the information terminal 1.

In addition, the velocity V2 may take multiple values. For example, the velocity V2 may be discontinuously accelerated over time. For example, the velocity V2 may be accelerated to twice the velocity V1 at first, and then increased to three times the velocity V1.

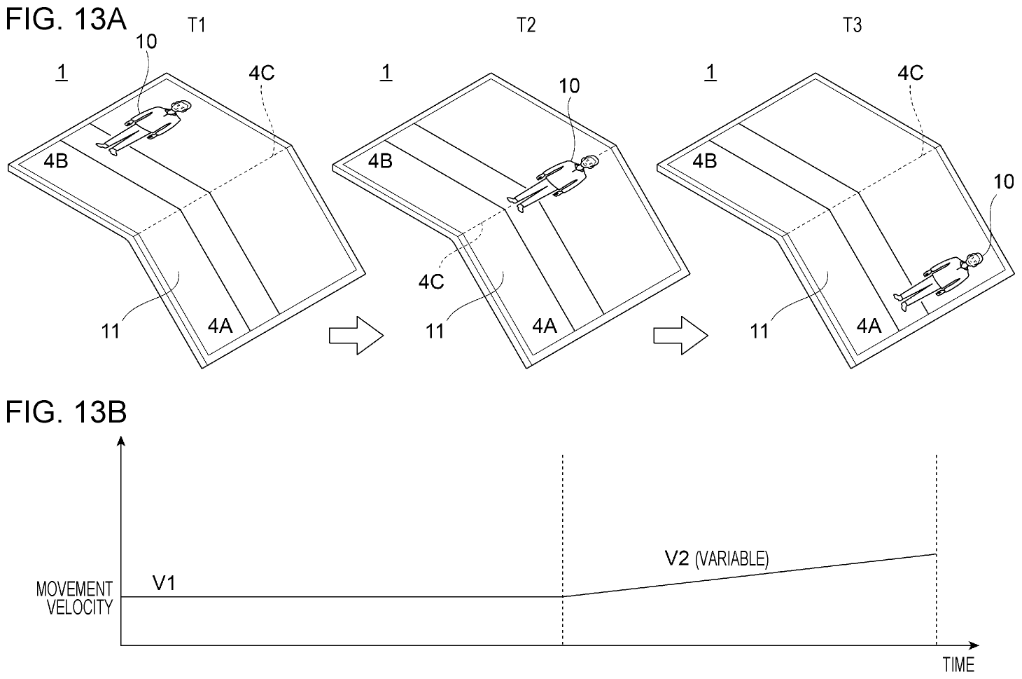

FIGS. 13A and 13B are diagrams illustrating another example of a change in movement velocity in the case where the information terminal 1 is deformed as a result of a mountain fold. FIG. 13A indicates the position at each time of the object image 10 displayed on the information terminal 1, and FIG. 13B indicates the velocity at each time used to move the object image 10. In FIGS. 13A and 13B, portions corresponding to those in FIGS. 12A and 12B are given the corresponding reference numerals.

In the case of FIGS. 13A and 13B, the movement velocity of the object image 10 in the display area 4A is different from that in FIGS. 12A and 12B in the point that the movement velocity is gradually increased over time. The initial value of the velocity V2 in the display area 4A is the same as the movement velocity V1 in the display area 4B. Unlike the case of FIGS. 12A and 12B, the movement velocity in the case of FIGS. 13A and 13B does not change discontinuously, resulting in a less uncomfortable feeling inspired by a change in velocity.

Note that the acceleration of the object image 10 may be stopped at a specific velocity. For example, when the movement velocity becomes three times the velocity V1, that movement velocity may be maintained.

Note that, in the examples illustrated in FIGS. 12A to 13B, the movement velocity of the object image 10 in the display area 4A is constant regardless of the magnitude of a change in the tilt angle with respect to the display area 4B. However, the magnitude of an effect of acceleration on the object image 10 in the display area 4A may be adjusted according to the magnitude of a change in the tilt angle. For example, the effect of acceleration may be greater as the change in the tilt angle becomes greater. For example, the effect of acceleration may be greater in the case where the change in tilt angle is 45 degrees than in the case where the change in tilt angle is 30 degrees, and the effect of acceleration may be greater in the case where the change in tilt angle is 60 degrees than in the case where the change in tilt angle is 45 degrees.

In addition, although the examples illustrated in FIGS. 12A to 13B also indicate the case where the movement velocity of the object image 10 in the display area 4B is constant, the movement velocity of the object image 10 in the display area 4B may be variable. For example, the object image 10 in the display area 4B may be accelerated or decelerated.

In addition, the change in movement velocity in the display areas 4A and 4B is not limited to be linear, but may be non-linear. For example, the movement velocity may change along a quadratic function or an exponential function. In addition, the movement velocity may be increased or decreased over time. The velocity is not limited to be increased or decreased once, but may be increased or decreased multiple times.

### Second Exemplary Embodiment

Although the case of changing the velocity of the object image 10 in accordance with deformation of the information terminal 1 has been described in the above-described exemplary embodiment, the case of adding a displayed effect for emphasizing the change in the tilt angle will be described in a second exemplary embodiment.

Therefore, the appearance configuration and the hardware configuration of the information terminal 1 in the present exemplary embodiment are common to the first exemplary embodiment.

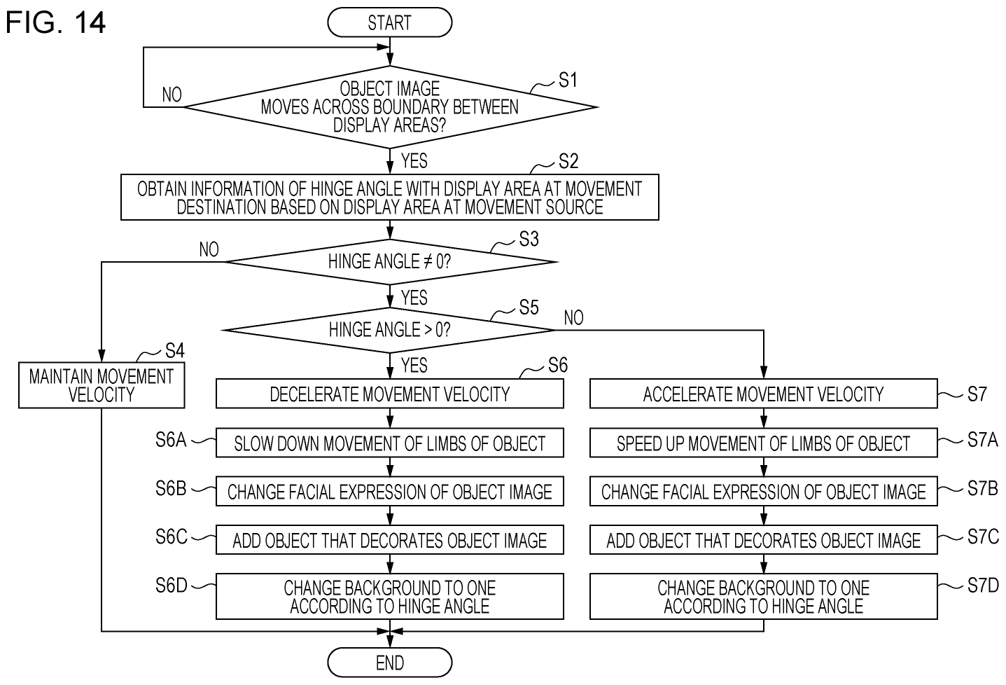

FIG. 14 is a flowchart illustrating an example of a process operation executed by the information terminal 1 used in the second exemplary embodiment. In FIG. 14, portions corresponding to those in FIG. 6 are given the corresponding reference numerals.

The process operation illustrated in FIG. 14 is different from the process operation illustrated in FIG. 6 in the point that steps S6A to S6D and steps S7A to S7D are added.

In the case of the present exemplary embodiment, steps S6A to S6D are executed after step S6.

Step S6A is a process of slowing down the movement of the limbs of the object. With execution of step S6A, the deceleration of the movement velocity involved in a change to an uphill road is emphasized. The movement, which has been slowed down, represents the difficulty of moving uphill.

For example, the number of rotations of the legs in the display area 4A becomes fewer than the number of rotations of the legs in the display area 4B.

In addition, for example, the speed of movement of the arms in the display area 4A becomes slower than the speed of movement of the arms in the display area 4B. Note that the number of rotations of the legs or the movement speed of the arms may be emphasized to distinguish the difference.

Step S6B is a process of changing the facial expression, form, or the like of the object image 10. With execution of step S6B, the difficulty of moving uphill is emphasized. By changing the facial expression, color, movement size, or the like of the object image 10, the difficulty of moving uphill is represented. Note that a change in the facial expression of the object image 10 is executed only in the case where the object is a human being or an anthropomorphic living thing. For example, the facial expression in the display area 4A looks more painful than the facial expression in the display area 4B.

For example, the stride in the display area 4A is made narrower than the stride in the display area 4B.

In addition, for example, the color of the object image 10 moving in the display area 4A is made redder than the color in the display area 4B. The redness represents an increase in heat or body temperature.

In addition, for example, the arm swing in the display area 4B is made smaller than the arm swing in the display area 4A.

Step S6C is a process of adding an object that decorates the object image 10. With execution of step S6C, the difficulty of moving uphill is emphasized. By adding sweat and/or steam rising from sweat to the object image 10, the difficulty of moving uphill is represented.

For example, an object that represents sweat is added to the object image 10 moving in the display area 4A.

In addition, for example, an object that represents steam is added to the object image 10 moving in the display area 4A.

In addition, for example, the clothes and shoes of the object image 10 moving in the display area 4A are changed to those suitable for moving uphill. Besides, a cane object is added, or an ice axe object is added.

In addition, for example, a transportation object such as a bike that assists with moving uphill is added to the object image 10 moving in the display area 4A.

Step S6D is a process of changing the background image 11 to one according to the hinge angle. With execution of step S6D, the fact that the display area 4B changes to an uphill road is emphasized. Note that it is preferable to change the content of the background image 11 according to the magnitude of a change in the tilt angle. For example, the background image 11 may be represented as a moderate uphill road in the case where θ1, which is the change in the tilt angle, is up to 30 degrees, may be represented as a steep uphill road in the case where θ1 exceeds 45 degrees, and may be represented as a cliff road in the case where θ1 exceeds 60 degrees.

Besides, the background image 11 in the display area 4A may be changed to rugged suburbs or mountains.

In contrast, steps S7A to S7D are executed after step S7.

Step S7A is a process of speeding up the movement of the limbs of the object. With execution of step S7A, the acceleration of the movement velocity involved in a change to a downhill road is emphasized. The movement of the arms and legs, which has been speeded up, represents that the movement is fast.

For example, the number of rotations of the legs in the display area 4A becomes greater than the number of rotations of the legs in the display area 4B.

In addition, for example, the speed of movement of the arms in the display area 4A becomes faster than the speed of movement of the arms in the display area 4B. Note that the number of rotations of the legs or the movement speed of the arms may be emphasized to distinguish the difference.

Step S7B is a process of changing the facial expression, form, or the like of the object image 10. With execution of step S7B, the easiness or painlessness of moving downhill is emphasized. By changing the facial expression, color, movement size, or the like of the object image 10, the easiness or the like of moving downhill is represented. Note that a change in the facial expression of the object image 10 is executed only in the case where the object is a human being or an anthropomorphic living thing. For example, the facial expression in the display area 4A looks less painful than the facial expression in the display area 4B.

For example, the stride in the display area 4A is made wider than the stride in the display area 4B.

In addition, for example, the color of the object image 10 moving in the display area 4A is made bluer than the color in the display area 4B. The blueness represents a decrease in heat or body temperature.

In addition, for example, the arm swing in the display area 4B is made bigger than the arm swing in the display area 4A.

Step S7C is a process of adding an object that decorates the object image 10. With execution of step S7C, the easiness or the like of moving downhill is emphasized. By adding wind or hair or body hair fluttering behind to the object image 10, the easiness or the like of moving downhill is represented.

For example, an object that represents wind is added to the object image 10 moving in the display area 4A.

For example, an object that represents hair or body hair fluttering in the wind is added to the object image 10 moving in the display area 4A.

In addition, for example, a sound effect that represents the fastness of the movement is added to the object image 10 moving in the display area 4A.

In addition, for example, the clothes and shoes of the object image 10 moving in the display area 4A are changed to those suitable for moving downhill. Besides, an object such as running shoes or roller skates may be added.

In addition, for example, a transportation object such as a skateboard or an automobile that emphasizes the fastness of the movement is added to the object image 10 moving in the display area 4A.

Step S7D is a process of changing the background image 11 to one according to the hinge angle. With execution of step S7D, the fact that the display area 4B changes to a downhill road is emphasized. Note that it is preferable to change the background image 11 according to the magnitude of a change in the tilt angle. For example, the background image 11 may be represented as a moderate downhill road in the case where θ2, which is the change in the tilt angle, is up to 30 degrees, may be represented as a steep downhill road in the case where θ2 exceeds 45 degrees, and may be represented as a cliff in the case where θ2 exceeds 60 degrees.

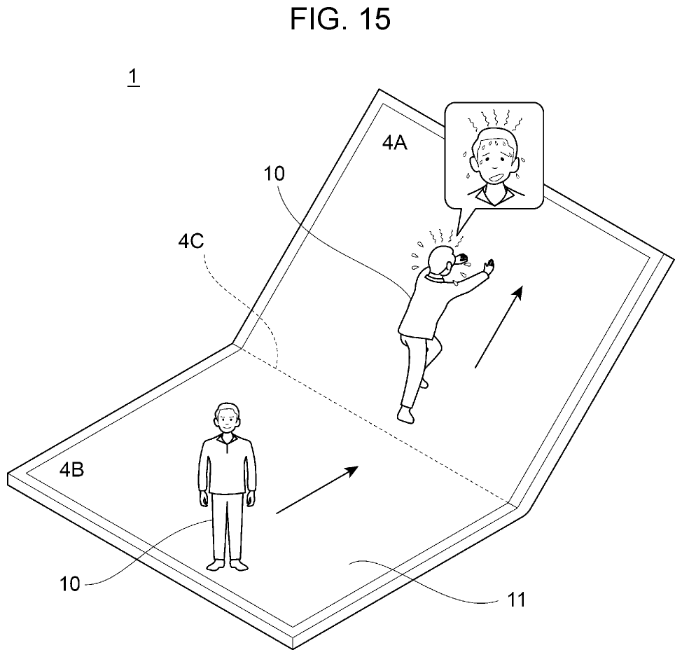

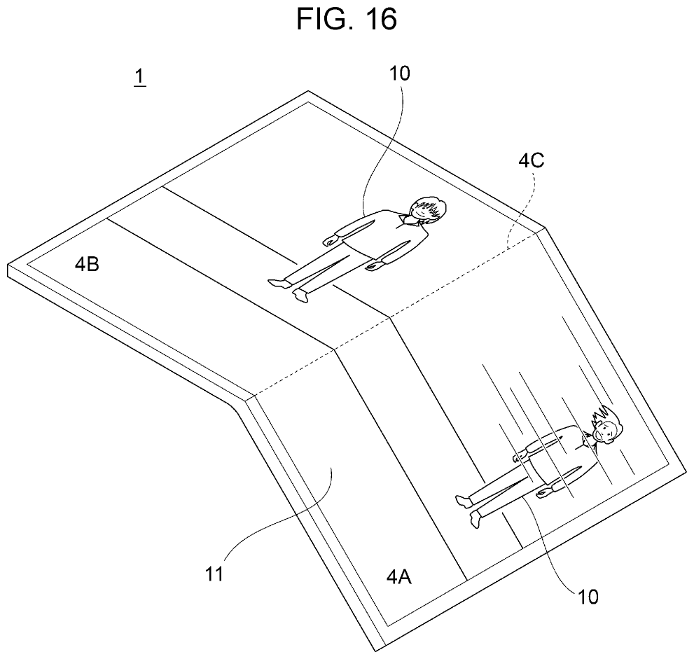

Hereinafter, specific examples of representation changes involved in movement across the display areas 4A and 4B formed as a result of folding and deformation will be described using FIGS. 15 and 16.

FIG. 15 is a diagram illustrating changes in representation in the case of deformation as a result of a valley fold. In the case of FIG. 15, the background image 11 in the display area 4B is parallel to a horizontal plane. Therefore, the object image 10 moves at a velocity designated by the user or app. When the object image 10 crosses the boundary 4C, the background image 11 in the display area 4A changes to a cliff. Therefore, the facial expression of the object image 10 changes to look painful. An object that represents sweat and an object that represents steam are added to the head. In addition, the arms and the legs are changed to a climbing posture.

In addition, the movement of the arms and the legs of the object image 10 is slower in the display area 4A, and the movement velocity is also slower.

FIG. 16 is a diagram illustrating changes in representation in the case of deformation as a result of a mountain fold. In the case of FIG. 16, the background image 11 in the display area 4B is also parallel to a horizontal plane. Therefore, the object image 10 moves at a velocity designated by the user or app. Note that hair hanging straight down is drawn at the head of the object image 10.

When the object image 10 crosses the boundary 4C, the background image 11 in the display area 4A changes to a downhill road. Therefore, the facial expression of the object image 10 changes to a smile. In addition, an object that represents hair fluttering behind is added to the head. In addition, straight lines representing the fastness of the movement are added around the object image 10.

In addition, the movement of the arms and the legs of the object image 10 is bigger in the display area 4A, and the movement velocity is also faster.

### Third Exemplary Embodiment

In a third exemplary embodiment, an information terminal with the function of communicating a change in the tilt of the display surface of the touchscreen 4 (see FIGS. 1A and 1B) where the object image 10 moves as a change in frictional force on a fingertip that moves the object image 10 will be described.

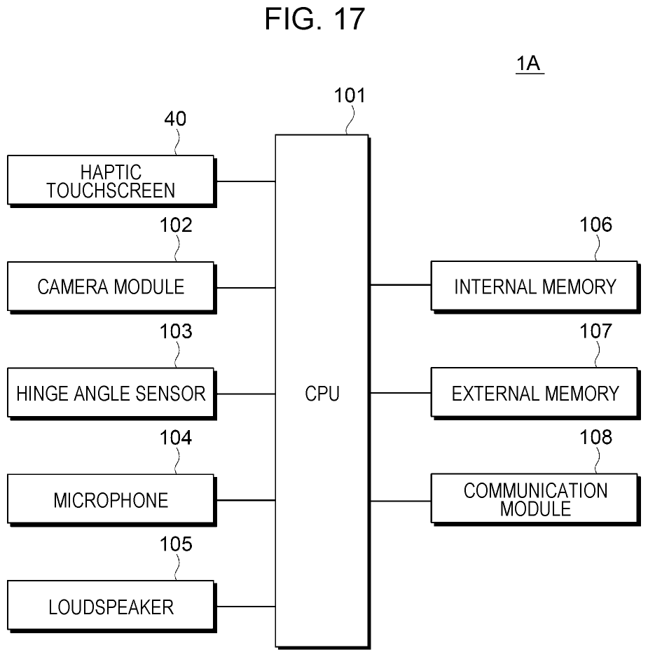

FIG. 17 is a diagram illustrating an example of the hardware configuration of an information terminal 1A used in the third exemplary embodiment. In FIG. 17, portions corresponding to those in FIG. 4 are given the corresponding reference numerals.

The information terminal 1A used in the present exemplary embodiment uses a haptic touchscreen 40 instead of the touchscreen 4 (see FIG. 4). The information terminal 1A is an example of an information processing apparatus.

The haptic touchscreen 40 is a display panel capable of generating a pseudo tactile stimulus by applying an electrostatic adsorption force to a fingertip that touches the panel surface.

Electrostatic adsorption is a technique for presenting a sense of touch by using an electrostatic force generated when a lower electrode connected to the ground potential and an upper electrode to which voltage is applied come close to each other. Specifically, a structure is adopted in which a thin insulating layer is provided between the upper electrode and the lower electrode, and the upper electrode and the lower electrode come close to each other without electrically contacting each other. At this time, each electrode is charged in an opposite direction, and an adsorption force is generated by the action of an electrostatic force. With this adsorption force, friction forces of various magnitudes may be applied to a fingertip touching the surface of the haptic touchscreen 40.

In the present exemplary embodiment, these frictional forces are used in order to make the user feel that it is an uphill road by limiting the movement of the fingertip after moving to the uphill road. In contrast, the frictional forces are also used to make the user feel that it is a downhill road by applying no frictional force to the fingertip after moving to the downhill road.

As the haptic touchscreen 40 giving a pseudo sense of touch, another type of display panel is available which changes the sense of touch according to the magnitude of an electrical stimulus applied to the fingertip.

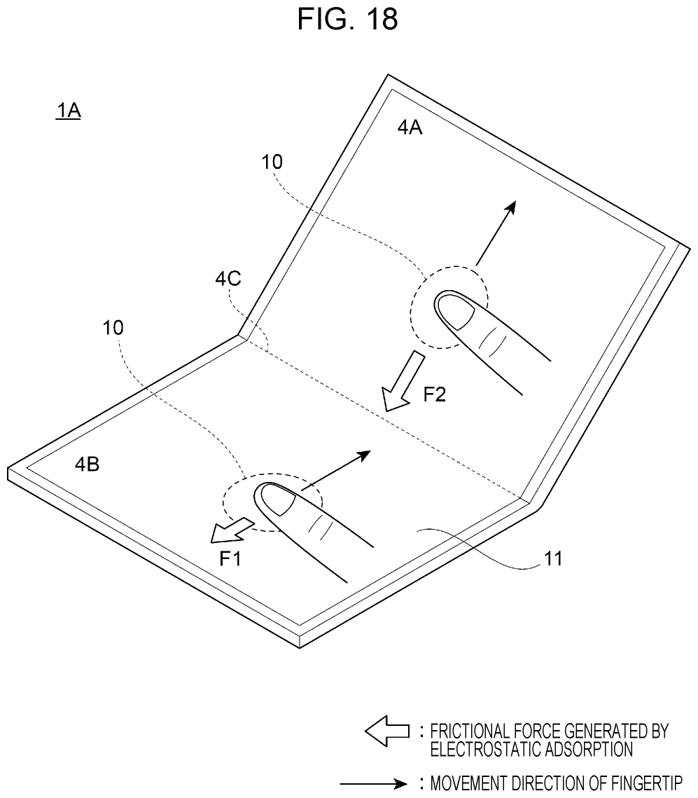

FIG. 18 is a diagram illustrating a change in frictional force applied to the fingertip in the case where the object image 10 moves across the two display areas 4A and 4B generated by deformation as a result of a valley fold. In FIG. 18, the object image 10 is assumed to have a coin shape.

In the case of FIG. 18, in the display area 4B at the movement source, a frictional force with a magnitude of F1 is applied in a direction opposite to the movement direction of the fingertip.

In contrast, when the object image 10 moves across the boundary 4C to the display area 4A, a frictional force with a magnitude of F2, which is greater than F1, is applied to the fingertip in a direction opposite to the movement direction of the fingertip.

Because the frictional force applied to the fingertip moving the object image 10 becomes greater, the user may actually feel a change to an uphill road through the sense of touch.

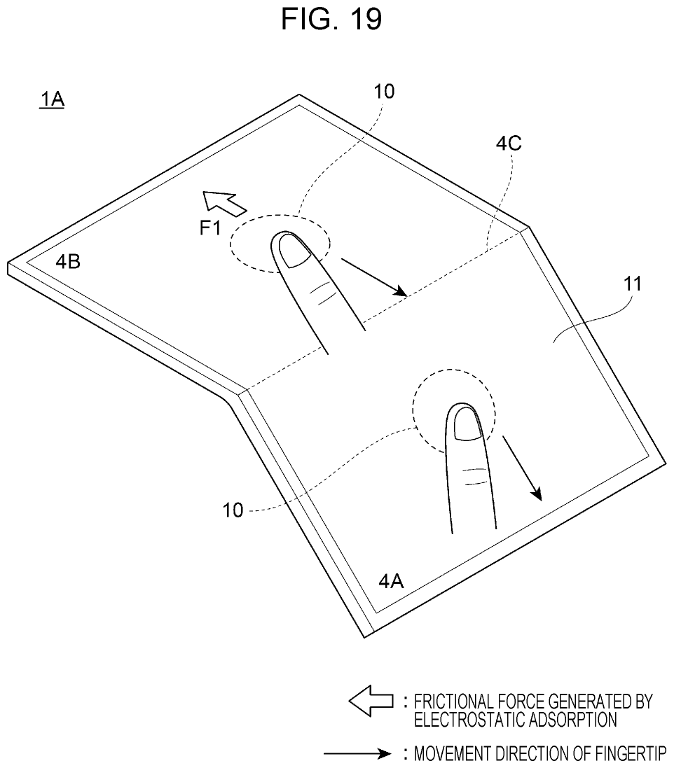

FIG. 19 is a diagram illustrating a change in frictional force applied to the fingertip in the case where the object image 10 moves across the two display areas 4A and 4B generated by deformation as a result of a mountain fold.

In the case of FIG. 19, in the display area 4B at the movement source, a frictional force with a magnitude of F1 is applied in a direction opposite to the movement direction of the fingertip.

In contrast, when the object image 10 moves across the boundary 4C to the display area 4A, no frictional force is applied to the fingertip anymore.

Therefore, the user may more easily move the object image 10 in the display area 4A than in the display area 4B. Accordingly, the user may actually feel a change to a downhill road through the sense of touch.

### Fourth Exemplary Embodiment

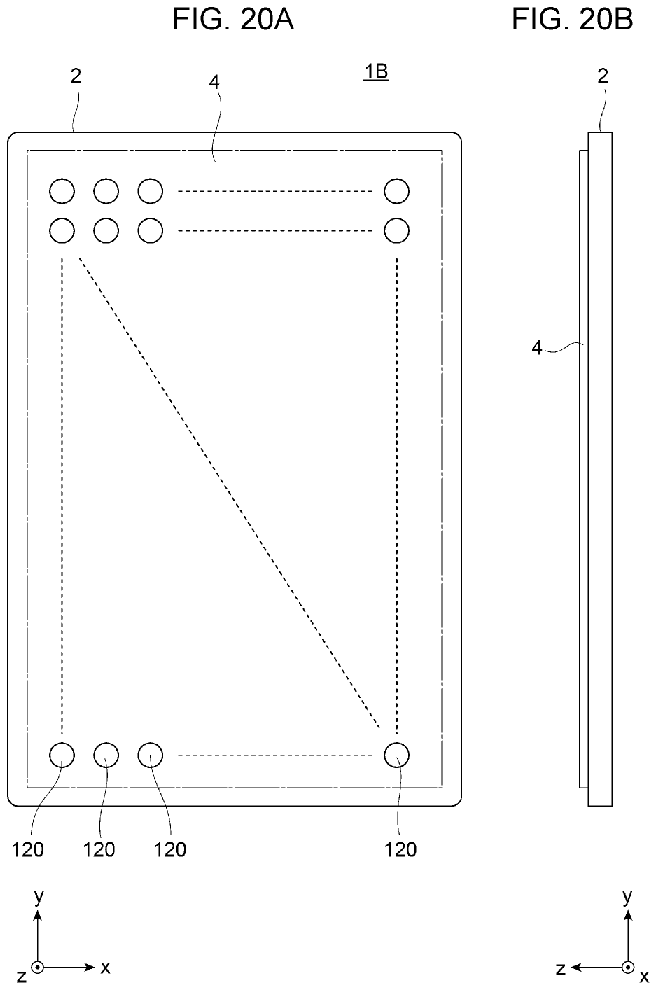

FIGS. 20A and 20B are diagrams illustrating an example of installing strain gauges 120 in an information terminal 1B used in a fourth exemplary embodiment. FIG. 20A is a front view of the information terminal 1B, and FIG. 20B is a side view of the information terminal 1B. The information terminal 1B is an example of an information processing apparatus.

The information terminal 1B used in the present exemplary embodiment is not provided with the hinge part 3. In addition, the main body 2 and the touchscreen 4 used in the present exemplary embodiment have a highly flexible substrate. Therefore, the main body 2 and the touchscreen 4 may be folded and deformed at an arbitrary position.

In the present exemplary embodiment, the strain gauges 120 are used in order to detect the position of folding and deformation and a change in the tilt angle between display areas involved in this folding and deformation. The strain gauges 120 are provided in a layer between the touchscreen 4 and the main body 2. In the case of FIGS. 20A and 20B, the multiple strain gauges 120 are arranged at equal intervals on the entire surface of the touchscreen 4. Needless to say, the strain gauges 120 may be arranged in a frame area which is the outer periphery of the touchscreen 4. In the case of the present exemplary embodiment, the shape of the touchscreen 4 after being folded and deformed is estimated on the basis of a distribution of the magnitudes of strains output from the strain gauges 120.

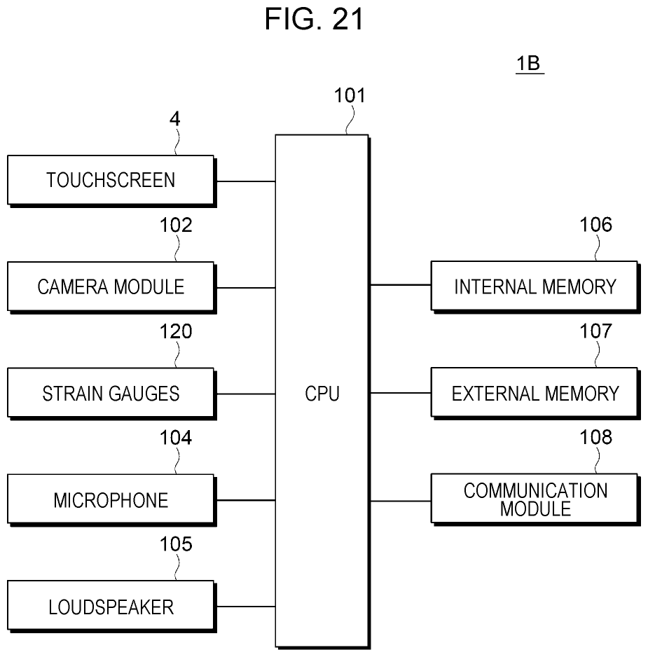

FIG. 21 is a diagram illustrating an example of the hardware configuration of the information terminal 1B used in the fourth exemplary embodiment. In FIG. 21, portions corresponding to those in FIG. 4 are given the corresponding reference numerals.

The information terminal 1B used in the present exemplary embodiment uses the strain gauges 120 instead of the hinge angle sensor 103 (see FIG. 4).

The strain gauges 120 have a structure in which a metal resistor having a zigzag layout is attached onto a thin insulator. Each of the strain gauges 120 measures a change in electrical resistance involved in deformation of the resistor, and converts the electrical resistance to the amount of strain of an object being measured. The strain gauges 120 are an example of a mechanical sensor.

The CPU 101 in the present exemplary embodiment estimates the shape of the touchscreen 4 after being folded and deformed from a distribution of information of the magnitudes of strains output from the strain gauges 120, and specifies the position of the boundary 4C (see FIG. 2). When the boundary 4C is specified, the CPU 101 specifies display areas that are adjacent to each other across the boundary 4C as the display areas 4A and 4B in the above-described exemplary embodiment. In addition, the CPU 101 estimates the direction and magnitude of a change in the tilt angle between the display areas 4A and 4B from the estimated shape after being folded and deformed. Using these pieces of information, the CPU 101 changes the representation of the object image 10 moving across the display areas 4A and 4B, as in the above-described exemplary embodiments.

### Other Exemplary Embodiments

Although the exemplary embodiments of the present disclosure have been described above, the technical scope of the present disclosure is not limited to the scope described in the above-described exemplary embodiments. It is clear from the description of the claims that the above-described exemplary embodiments with various modifications or improvements are also included in the technical scope of the present disclosure.

(1) Although the above-described exemplary embodiments are described on the premise that the background image 11 corresponding to a display area A and a display area B is on the ground in both the display areas A and B, in the case of deformation as a result of a valley fold, the display area B at the movement source may be on the ground and the display area A at the movement destination may be in the air. In addition, in the case of deformation as a result of a mountain fold, the display area B at the movement source may be on the ground, and the display area A at the movement destination may be underwater or underground.

In addition, both the display area A and the display area B may be in the air, underground, or underwater. In addition, both the display area A and the display area B may be represented as the interior of a structure such as a building or a tunnel.

(2) Although the above-described exemplary embodiments are described on the premise that the display area 4B at the movement source for the object image 10 is horizontal in the actual space, the display area 4B may be tilted in the actual space.

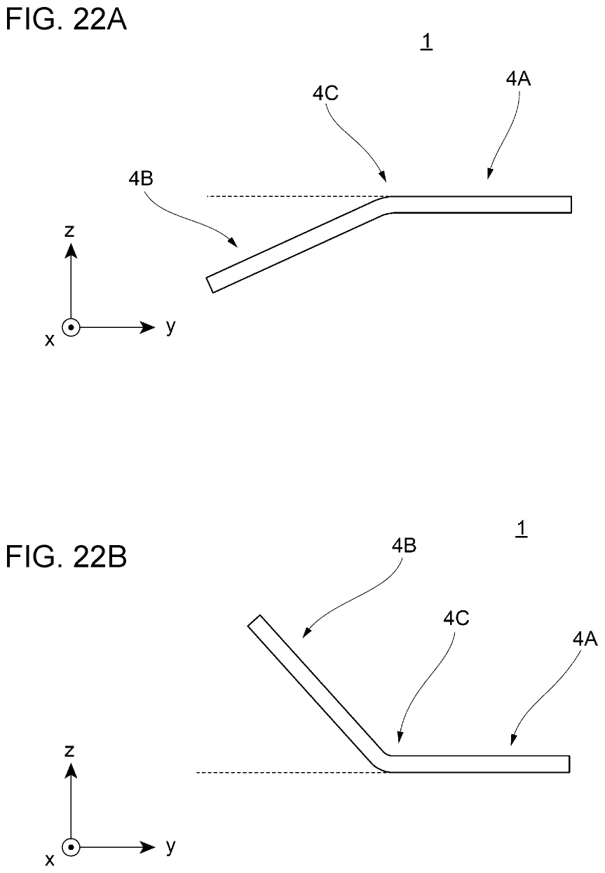

FIGS. 22A and 22B are diagrams illustrating the case where the display area 4A corresponding to the movement destination for the object image 10 (see FIG. 5) is parallel to a horizontal plane. FIG. 22A indicates the relationship between the display area 4A at the movement source and the display area 4B at the movement destination in the case of deformation as a result of a mountain fold, and FIG. 22B indicates the relationship between the display area 4B at the movement source and the display area 4A at the movement destination in the case of deformation as a result of a valley fold.

In the case of deformation as a result of a mountain fold illustrated in FIG. 22A, movement in the display area 4B is uphill, whereas, after moving across the boundary 4C to the display area 4A, it becomes a flat road. Therefore, the representation of the object image 10 changes. In addition, the frictional force applied to the fingertip may be changed, as in the case of the fourth exemplary embodiment.

In the case of deformation as a result of a valley fold illustrated in FIG. 22B, movement in the display area 4B is downhill, whereas, after moving across the boundary 4C to the display area 4A, it changes to a flat road. Therefore, the representation of the object image 10 changes. In addition, the frictional force applied to the fingertip may be changed, as in the case of the fourth exemplary embodiment.

(3) In the above-described exemplary embodiments, the case in which the display of the information terminal 1 (see FIGS. 1A and 1B) is always exposed has been described. However, the display may be structured to be pulled out only when used and be accommodated when not used.

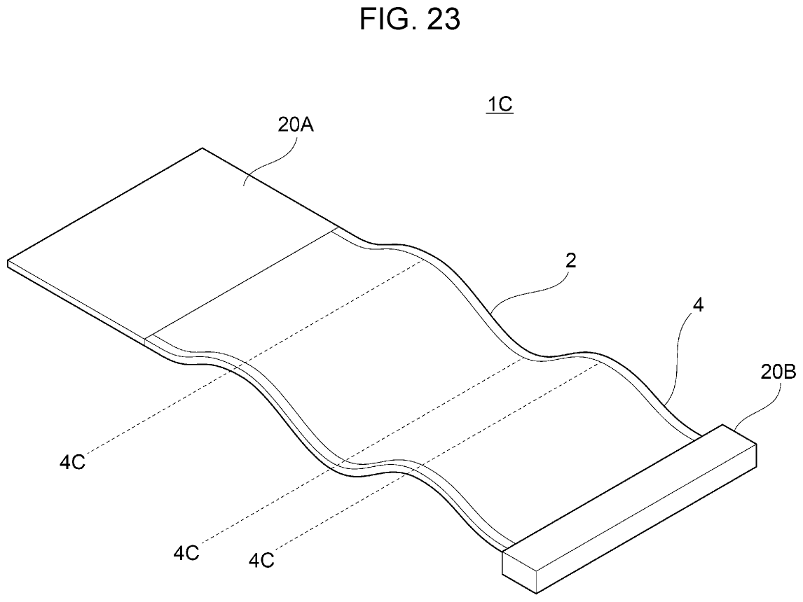

FIG. 23 is a diagram illustrating an example of the appearance configuration of another information terminal 1C. The information terminal 1C is also an example of an information processing apparatus.

The information terminal 1C illustrated in FIG. 23 includes an apparatus main body 20A, which accommodates the film-shaped main body 2 in a rolled state, which is provided with one touchscreen 4 having a deformable display surface, and a pull-out member 20B, which is attached to one end side of the main body 2.

In the case of FIG. 23, the touchscreen 4 pulled out from the apparatus main body 20A has a cockle shape due to deformation. Therefore, three boundaries 4C are formed. In this case, the representation of the object image 10 (see FIG. 5) changes when the object image 10 moves across four display areas separated by the three boundaries 4C.

(4) Although the information terminal 1 (see FIGS. 1A and 1B) having the hinge part 3 (see FIGS. 1A and 1B) has been described in the above-described first exemplary embodiment, the information terminal 1 may have multiple hinge parts 3.

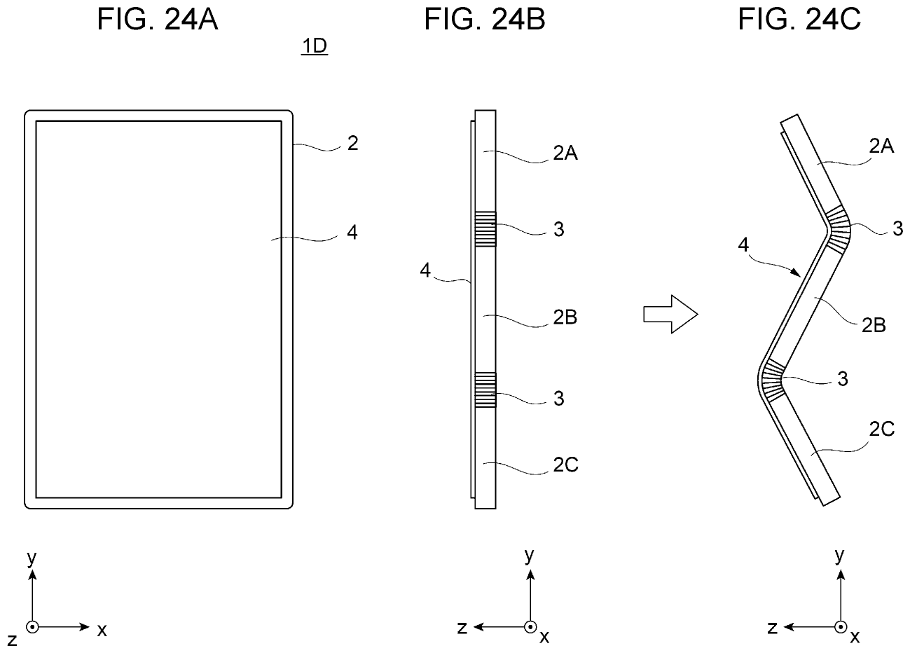

FIGS. 24A to 24C are diagrams illustrating an example of the appearance configuration of another information terminal 1D. FIG. 24A is a front view of the information terminal 1D, FIG. 24B is a side view of the information terminal 1D, and FIG. 24C illustrates an example of the shape of the information terminal 1D after being deformed. In FIGS. 24A to 24C, portions corresponding to those in FIGS. 1A and 1B are given the corresponding reference numerals. The information terminal 1D is also an example of an information processing apparatus.

Members constituting the information terminal 1D illustrated in FIGS. 24A to 24C are basically the same as those of the information terminal 1 (see FIGS. 1A and 1B) described in the first exemplary embodiment. Because two hinge parts 3 are provided in the case of the present exemplary embodiment, the touchscreen 4 is separated into three display areas.

Note that the main body 2 includes three main body panels 2A, 2B, and 2C connected by the two hinge parts 3. Therefore, as illustrated in FIG. 24C, when viewed from a lateral side, the information terminal 1D may be deformed to an uphill shape, a downhill shape, and an uphill shape, from the left side to the right side.

(5) In the case of the above-described exemplary embodiments, the case in which the information terminal 1 (see FIGS. 1A and 1B) has one deformable touchscreen 4 (see FIGS. 1A and 1B) has been described. However, there may be multiple touchscreens 4.

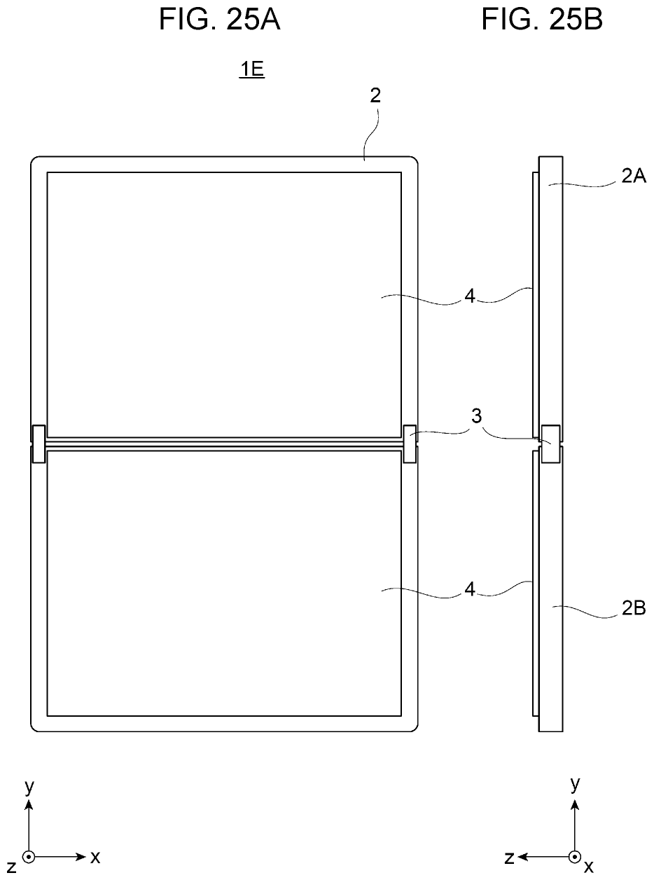

FIGS. 25A and 25B are diagrams illustrating an example of the appearance configuration of another information terminal 1E. FIG. 25A is a front view of the information terminal 1E, and FIG. 25B is a side view of the information terminal 1E. In FIGS. 25A and 25B, portions corresponding to those in FIGS. 1A and 1B are given the corresponding reference numerals. The information terminal 1E is also an example of an information processing apparatus.

The information terminal 1E illustrated in FIGS. 25A and 25B has a display surface composed of two touchscreens 4. These two touchscreens 4 are capable of displaying one continuous image.

In the case of the information terminal 1E, the main body panel 2A and the main body panel 2B are rotatably attached to the hinge part 3. The hinge part 3 has a built-in rotation shaft for rotatably attaching the main body panel 2A and a built-in rotation shaft for rotatably attaching the main body panel 2B. Therefore, the touchscreens 4 may be folded inward or outward.

The main body panel 2A, the main body panel 2B, and the touchscreens 4 used in the present exemplary embodiment all have high rigidity and do not deform by themselves.

(6) In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to
change a representation of an image of an object displayed on a deformable display in accordance with a change in tilt of a partial display area occurring due to a shape change of the deformable display.

2. The information processing apparatus according to claim 1, wherein, in a case where tilt of a display area at a movement destination changes with respect to a display area at a movement source, the processor is configured to give an effect of changing an amount of movement of the image of the object.

3. The information processing apparatus according to claim 1, wherein the processor is configured to change a velocity of movement of the image of the object according to a magnitude of the change in tilt.

4. The information processing apparatus according to claim 3, wherein, in a case where the change in tilt is upward, the processor is configured to decelerate the movement of the image of the object according to the magnitude of the change.

5. The information processing apparatus according to claim 3, wherein, in a case where the change in tilt is upward, the processor is configured to increase an effect of deceleration as a distance of the movement of the image of the object in a display area at a movement destination becomes longer.

6. The information processing apparatus according to claim 5, wherein, after the movement of the image of the object stops, the processor is configured to move the image of the object in an opposite direction.

7. The information processing apparatus according to claim 3, wherein, in a case where the change in tilt is downward, the processor is configured to accelerate the movement of the image of the object according to the magnitude of the change.

8. The information processing apparatus according to claim 1, wherein, in a case where tilt of a display area at a movement destination changes with respect to a display area at a movement source, the processor is configured to give an effect of changing a form of the image of the object.

9. The information processing apparatus according to claim 8, wherein, in a case where the object is an animal, the processor is configured to change a speed of movement of the animal according to a magnitude of the change in tilt.

10. The information processing apparatus according to claim 9, wherein, in a case where the change in tilt is upward, the processor is configured to apply control to slow down the movement of the animal.

11. The information processing apparatus according to claim 9, wherein, in a case where the change in tilt is downward, the processor is configured to apply control to speed up the movement of the animal.

12. The information processing apparatus according to claim 9, wherein the processor is configured to add an object representing sweat or steam to the animal.

13. The information processing apparatus according to claim 10, wherein the processor is configured to add an object representing sweat or steam to the animal.

14. The information processing apparatus according to claim 11, wherein the processor is configured to add an object representing sweat or steam to the animal.

15. The information processing apparatus according to claim 1, wherein the processor is configured to change content of a background displayed behind the object in accordance with a change in tilt of a display area at a movement destination.

16. The information processing apparatus according to claim 1, wherein, in a case where tilt of a display area at a movement destination changes with respect to a display area at a movement source, the processor is configured to give a change to a sense of touch that is electrically applied to a fingertip of a user who moves the displayed object.

17. The information processing apparatus according to claim 16, wherein the processor is configured to change a sense of friction applied to the fingertip as the sense of touch.

18. A non-transitory computer readable medium storing a program causing a computer to execute a process, the process comprising:
changing a representation of an image of an object displayed on a deformable display in accordance with a change in tilt of a partial display area occurring due to a shape change of the deformable display.

19. An information processing apparatus comprising:
means for changing a representation of an image of an object displayed on a deformable display in accordance with a change in tilt of a partial display area occurring due to a shape change of the deformable display.
